(19) United States
(12) Patent Application Publication
(10) Pub. No.: US 2025/0362397 A1
(43) Pub. Date: Nov. 27, 2025

(54) INFORMATION PROCESSING APPARATUS, METHOD, AND PROGRAM FOR CALCULATING FOCAL DISTANCE

(71) Applicant: JVCKENWOOD Corporation, Yokohama-shi (JP)

(72) Inventor: Toshihide KOBAYASHI, Yokohama-shi (JP)

(21) Appl. No.: 19/290,408

(22) Filed: Aug. 5, 2025

Related U.S. Application Data
(63) Continuation of application No. PCT/JP2024/004041, filed on Feb. 7, 2024.

(30) Foreign Application Priority Data
Feb. 16, 2023 (JP) 2023-022108
Feb. 16, 2023 (JP) 2023-022109

(51) Int. Cl. G01S 7/497; G01S 7/481; G01S 17/89

(52) U.S. Cl. CPC G01S 7/497; G01S 7/4816; G01S 17/89

(57) ABSTRACT

In an information processing apparatus, an acquisition unit acquires ranging values of a TOF sensor. A calculation unit calculates a focal distance of an optical system, based on at least one of a horizontal ranging value of an observation point of a subject or a vertical ranging value of an observation point of the subject, a central ranging value of an observation point of the subject, a distance from the light receiving surface to a rear principal surface of the optical system, a distance from the light receiving surface to a position of an entrance pupil of the optical system, and an effective size of the TOF sensor.

### CROSS-REFERENCE TO RELATED APPLICATION

This application is a continuation of application No. PCT/JP2024/004041, and claims the benefit of priority from the prior Japanese Patent Application No. 2023-22108 and No. 2023-22109, filed on Feb. 16, 2023, the entire contents of which is incorporated herein by reference.

### BACKGROUND

### 1. Field of the Invention

The present disclosure relates to an information processing apparatus, method and program.

### 2. Description of the Related Art

A TOF camera is known to measure the distance to a subject in the ranging region by using the time of flight (TOF: time of flight) for light to obtain point cloud data for three-dimensional x, y, z coordinates of the subject (see, for example, Patent Literature 1). Generally, the ranging distance acquired by the TOF camera is converted to point cloud data for three-dimensional x, y, z coordinates by using the focal distance set without considering the thickness of the lens.
[Patent Literature 1] JP 2020-153865

### SUMMARY

In practice, however, a lens has a thickness. When the focal distance set without considering the thickness of the lens is used, therefore, there is a problem in that the error from the actual focal distance is large.

An information processing apparatus according to an embodiment includes: an acquisition unit that acquires, from a TOF sensor that generates a distance image comprised of a plurality of ranging values corresponding to a time of flight for light elapsed until a projected light is reflected by a subject, passes through an optical system, and is received by a light receiving surface, the plurality of ranging values; and a calculation unit that calculates a focal distance of the optical system in at least one of a horizontal direction or a vertical direction, based on i) of the plurality of ranging values, at least one of a horizontal ranging value that is a ranging value of an observation point of the subject aligned with a maximum angle of view of the TOF sensor in the horizontal direction or a vertical ranging value that is a ranging value of an observation point of the subject aligned with the maximum angle of view of the TOF sensor in the vertical direction, ii) of the plurality of ranging values, a central ranging value that is a ranging value of an observation point of the subject aligned with a central portion of the angle of view of the TOF sensor, iii) a distance from the light receiving surface to a rear principal surface of the optical system, iv) a distance from the light receiving surface to a position of an entrance pupil of the optical system, and v) an effective size of the TOF sensor in at least one of the horizontal direction or the vertical direction.

An information processing apparatus according to another embodiment includes: an acquisition unit that acquires, from a TOF sensor that generates a distance image comprised of a plurality of ranging values corresponding to a time of flight for light elapsed until a projected light is reflected by a subject, passes through an optical system, and is received by a light receiving surface, the distance image of the subject; a correction unit that subjects the distance image to distortion correction; a calculation unit that calculates a focal distance of the optical system in at least one of a horizontal direction or a vertical direction, based on i) at least one of a horizontal ranging value that is a ranging value at an end of the distance image subjected to distortion correction in a horizontal direction or a vertical ranging value that is a ranging value at an end of the distance image subjected to distortion correction in a vertical direction, ii) a central ranging value that is a ranging value in a central portion of the distance image subjected to distortion correction, iii) a distance from the light receiving surface to a rear principal surface of the optical system, iv) a distance from the light receiving surface to a position of an entrance pupil of the optical system, and v) an effective size of the TOF sensor in at least one of the horizontal direction or the vertical direction; and a storage unit that stores the focal distance calculated.

A method according to an embodiment includes: acquiring, from a TOF sensor that generates a distance image comprised of a plurality of ranging values corresponding to a time of flight for light elapsed until a projected light is reflected by a subject, passes through an optical system, and is received by a light receiving surface, the plurality of ranging values; and calculating a focal distance of the optical system in at least one of a horizontal direction or a vertical direction, based on i) of the plurality of ranging values, at least one of a horizontal ranging value that is a ranging value of an observation point of the subject aligned with a maximum angle of view of the TOF sensor in the horizontal direction or a vertical ranging value that is a ranging value of an observation point of the subject aligned with the maximum angle of view of the TOF sensor in the vertical direction, ii) of the plurality of ranging values, a central ranging value that is a ranging value of an observation point of the subject aligned with a central portion of the angle of view of the TOF sensor, iii) a distance from the light receiving surface to a rear principal surface of the optical system, iv) a distance from the light receiving surface to a position of an entrance pupil of the optical system, and v) an effective size of the TOF sensor in at least one of the horizontal direction or the vertical direction.

A method according to another embodiment includes: acquiring, from a TOF sensor that generates a distance image comprised of a plurality of ranging values corresponding to a time of flight for light elapsed until a projected light is reflected by a subject, passes through an optical system, and is received by a light receiving surface, the distance image of the subject; subjecting the distance image to distortion correction; calculating a focal distance of the optical system in at least one of a horizontal direction or a vertical direction, based on i) at least one of a horizontal ranging value that is a ranging value at an end of the distance image subjected to distortion correction in a horizontal direction or a vertical ranging value that is a ranging value at an end of the distance image subjected to distortion correction in a vertical direction, ii) a central ranging value that is a ranging value in a central portion of the distance image subjected to distortion correction, iii) a distance from the light receiving surface to a rear principal surface of the optical system, iv) a distance from the light receiving surface to a position of an entrance pupil of the optical system, and v) an effective size of the TOF sensor in at least one of the horizontal direction or the vertical direction; and storing the focal distance calculated.

A program according to an embodiment includes computer-implemented modules including: a module that acquires, from a TOF sensor that generates a distance image comprised of a plurality of ranging values corresponding to a time of flight for light elapsed until a projected light is reflected by a subject, passes through an optical system, and is received by a light receiving surface, the plurality of ranging values; and a module that calculates a focal distance of the optical system in at least one of a horizontal direction or a vertical direction, based on i) of the plurality of ranging values, at least one of a horizontal ranging value that is a ranging value of an observation point of the subject aligned with a maximum angle of view of the TOF sensor in the horizontal direction or a vertical ranging value that is a ranging value of an observation point of the subject aligned with the maximum angle of view of the TOF sensor in the vertical direction, ii) of the plurality of ranging values, a central ranging value that is a ranging value of an observation point of the subject aligned with a central portion of the angle of view of the TOF sensor, iii) a distance from the light receiving surface to a rear principal surface of the optical system, iv) a distance from the light receiving surface to a position of an entrance pupil of the optical system, and v) an effective size of the TOF sensor in at least one of the horizontal direction or the vertical direction.

Optional combinations of the aforementioned constituting elements, and implementations of the embodiments in the form of methods, apparatuses, systems, recording mediums, and computer programs may also be practiced as modes of the embodiments.

### BRIEF DESCRIPTION OF THE DRAWING

Embodiments will now be described, by way of example only, with reference to the accompanying drawings which are meant to be exemplary, not limiting, and wherein like elements are numbered alike in several Figures, in which:

FIG. 1 shows a pinhole lens model on the horizontal plane;

FIG. 2 shows a pinhole lens model on the vertical plane;

FIG. 3 shows a method of converting the ranging value of the TOF sensor to three-dimensional point cloud data;

FIG. 4 shows a method of converting the ranging value of the TOF sensor to three-dimensional point cloud data;

FIG. 5 shows a lens model on the horizontal plane in which the optical path length of the lens is considered;

FIG. 6 shows a lens model on the vertical plane in which the optical path length of the lens is considered;

FIG. 7 shows a configuration of the TOF camera of the first embodiment;

FIG. 8 is a flowchart showing a step of the information processing apparatus related to calibration according to the first embodiment;

FIG. 9 is a flowchart of a step of the information processing apparatus performed when a subject to be photographed is photographed to obtain three-dimensional point cloud data according to the first embodiment;

FIG. 10A shows a distance image obtained by using a distorted lens, and FIG. 10B shows an image obtained by subjecting the distance image of FIG. 10A to distortion correction;

FIG. 11 shows a functional block diagram of the information processing apparatus of the second embodiment.

FIG. 12 is a flowchart showing a step in the first stage for checking whether the TOF camera is positioned perpendicular to its optical axis;

FIG. 13 shows regions at the four corners of the screen in the distortion-corrected distance image of the white chart;

FIG. 14 is a flowchart showing a step in the second stage for calculating the focal distance according to the second embodiment;

FIG. 15 shows a region in the center of the screen, regions located at the upper and lower ends with respect to the center of the screen, regions at the left and right ends with respect to the center of the screen in the distortion-corrected distance image of the white chart;

FIG. 16 is a flowchart of a step of the information processing apparatus performed when the subject to be photographed is photographed to obtain three-dimensional point cloud data according to the second embodiment;

FIG. 17 shows a configuration of the TOF camera of the third embodiment;

FIG. 18 shows a configuration of the TOF camera of the fourth embodiment;

FIG. 19 shows a configuration of the TOF camera of the fifth embodiment; and

FIG. 20 shows the reflection spectral characteristics of the visible light reflection dichroic film.

### DETAILED DESCRIPTION

The invention will now be described by reference to the preferred embodiments. This does not intend to limit the scope of the present invention, but to exemplify the invention.

### First Embodiment

In the TOF camera, the distance from the TOF sensor to each observation point of the subject is measured, and multiple ranging values d obtained are converted to point cloud data in a three-dimensional x, y, z coordinate system (hereinafter referred to as three-dimensional point cloud data). In this process, a pinhole lens model with the simplest optical path of the lens is generally used.

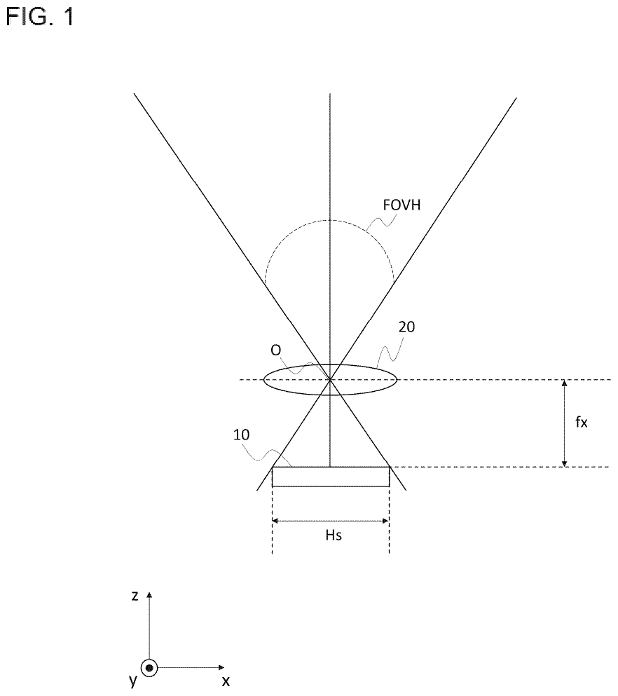

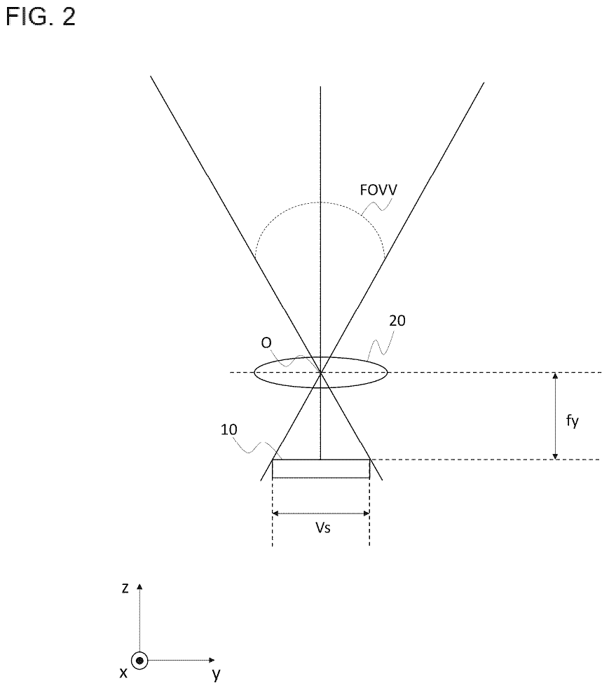

FIG. 1 shows a pinhole lens model on the H (horizontal) plane viewed from the y direction, and FIG. 2 shows a pinhole lens model on the V (vertical) plane viewed from the x direction. FOVH in FIG. 1 and FOVV in FIG. 2 denote the maximum angle of view that the effective pixels of a TOF sensor 10 can capture. Hs in FIG. 1 and Vs in FIG. 2 denote the sizes (distance dimension) of the effective pixels of the TOF sensor 10 in the horizontal and vertical directions, respectively. Hereinafter, the size of the effective pixels of the TOF sensor 10 in the horizontal direction and in the vertical direction may simply be referred to as the effective size.

The light of an image received by the TOF sensor 10 passes through the point at the center O of the lens 20. The effective pixels vary depending on the aspect ratio of the TOF sensor 10. In the 4:3 aspect ratio, for example, Hs:Vs will be 4:3. Therefore, the angle of view differs in the horizontal and in the vertical direction so that a focal distance fx between the TOF sensor 10 and the lens 20 in the horizontal direction (see FIG. 1; hereinafter, a horizontal focal distance fx) and a focal distance fy in the vertical direction (see FIG. 2; hereinafter, a vertical focal distance fy) are respectively defined in the TOF sensor 10. A method of setting the horizontal focal distance fx and the vertical focal distance fy will be described later.

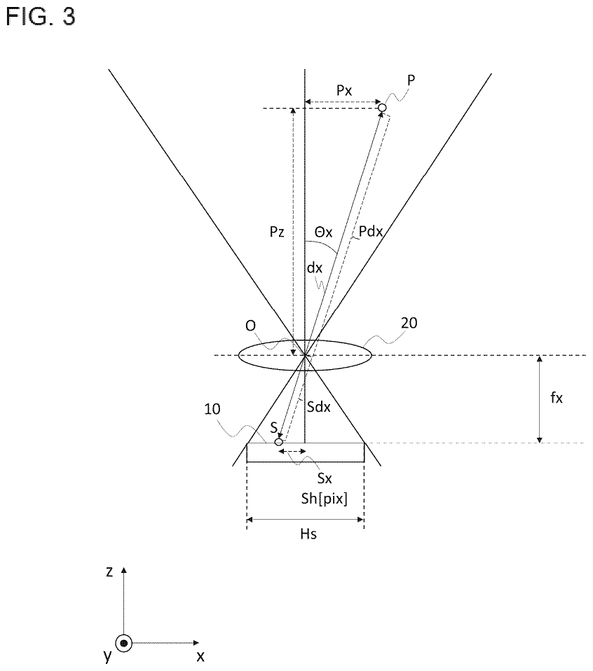

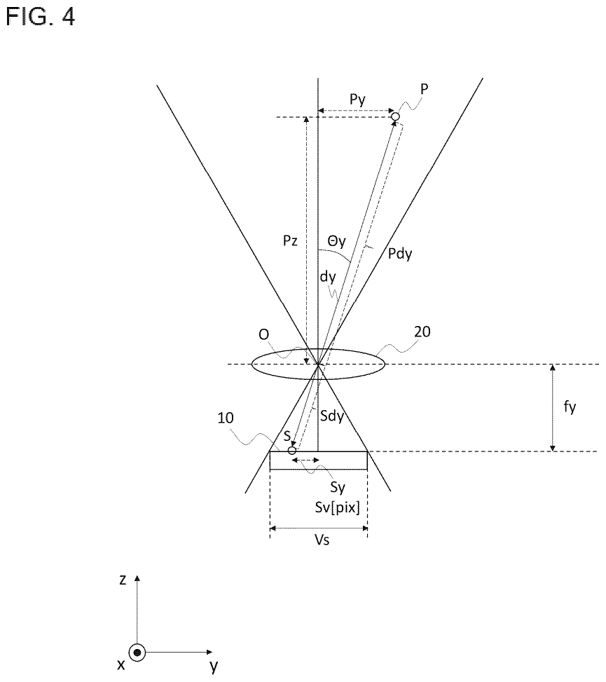

FIGS. 3 and 4 show a method of converting the ranging value d between the TOF sensor 10 and the subject to three-dimensional point cloud data x, y, z by using the pinhole lens model. FIGS. 3 and 4 show the lens viewed from the y direction and the x direction, respectively. The TOF sensor 10 is a sequential scan sensor that scans a line horizontally in units of pixels and scans the next line in the vertical direction when one line is scanned. Two-dimensional pixel data comprised of multiple ranging values d thus acquired by the TOF sensor 10 is also referred to as a distance image.

When point P, which is an observation point in the subject, is captured by pixel S (point S) on the light receiving surface of the TOF sensor 10, the ranging value d from point S to point P is obtained based on the output of the TOF sensor 10. This ranging value d is converted to three-dimensional point cloud data x, y, z. Given that the central position O of the lens 20 is the origin of the three-dimensional point cloud data x, y, z (x=0, y=0, z=0), Px of FIG. 3 represents the point cloud data for point P in the x direction, and the distance Py of FIG. 4 represents the point cloud data for point P in the y direction. Given that the pixel arrangement on the light receiving surface of the TOF sensor 10 is an array of square pixels and that the pitch between pixels is Sp [mm], the actual distance Sx [mm] of point S distanced from the horizontal center of the light receiving surface of the TOF sensor 10 by Sh pixel S in the horizontal direction is given by the following expression (1).

Sx=Sh×Sp expression (1)

Similarly, the actual distance Sy [mm] of point S distanced from the vertical center of the light receiving surface of the TOF sensor 10 by Sv pixels in the vertical direction is given by the following expression (2).

Sy=Sv×Sp expression (2)

As shown in FIGS. 3 and 4, point P is defined as an observation point of a subject at a position tilted horizontally and vertically by Θx and Θy, respectively, with respect to the optical axis of the lens 20. Representing the ranging value d in the x, z plane of FIG. 3, the ranging value d is converted to a distance dx given by the following expression (3).

dx=d×cos(Θy) expression (3)

Referring to FIG. 4, a triangle including point S and formed by the sides Sdy, Sy, and fy and a triangle including point P and formed by the sides Pdy, Py, Pz are similar so that Θy is given by expression (4) as follows. The distance Sdx is given by the following expression (5).

Θy=arctan(Sy/fy) expression (4)

Sdx=fx/cos(Θx) expression (5)

Referring to FIG. 3, a triangle including point S and formed by the sides Sdx, Sx, and fx and a triangle including point P and formed by the sides Pdx, Px, Pz are similar so that Θx is given by expression (6) as follows. The distance Sdx and the distances Pz and Px after point cloud conversion are given by the following expressions (7)-(9).

Θx=arctan(Sx/fx) expression (6)

Pdx=dx−Sdx expression (7)

Pz=Pdx×cos(Θx) expression (8)

Px=Pdx×sin(Θx) expression (9)

Similarly, the distances dy, Sdy, Pdy, and the distance Py after point cloud conversion are given by the following expressions (10)-(13), respectively.

dy=dx cos(Θx) expression (10)

Sdy=fy/cos(y) expression (11)

Pdy=dy−Sdy expression (12)

Py=Pdy×sin(Θy) expression (13)

Conventionally, the focal distance f is set in the horizontal and vertical directions based on, for example, the known theoretical formula shown below, disregarding the thickness of the lens, where n denotes the refractive index of the lens, R1 denotes the radius of curvature of the incidence surface of the lens, and R2 denotes the radius of curvature of the output surface of the lens.

(n−1)((1/R1)−(1/R2))=1/f

Thus, conventionally, the horizontal focal distance fx and vertical focal distance fy of the pinhole lens model are set without considering the thickness of the lens 20, and the ranging value d is converted to three-dimensional point cloud data x, y, z accordingly. In the case of a TOF camera using multiple lenses or a TOF camera using a zoom lens, however, there is a difference between the position of the entrance pupil and the position of the rear principal plane due to the physical length of the lens, creating a slight change in the maximum angle of view. Therefore, an error is created in the horizontal focal distance fx and the vertical focal distance fy. As a result, there is a problem in that three-dimensional point cloud data cannot be obtained accurately from the ranging value.

According to one known scheme, this is addressed by photographing and capturing multiple images of a checkered pattern chart at different spatial orientations and positions. The captured images data are treated as solutions of the determinant of the pinhole lens model, and the coefficients of the determinant are determined from the multiple solutions. The horizontal focal distance fx and the vertical focal distance fy are calibrated accordingly. However, this scheme requires acquiring multiple images at different orientations and angles of view and so requires a lot of man-hours for calibration. Furthermore, the calibration is easily affected by lighting and noise of the captured image. Accordingly, there is a problem in that it is difficult to obtain the horizontal focal distance fx and the vertical focal distance fy with good accuracy.

In view of the above, the focal distance calculation method in the first embodiment of the present disclosure will be described below.

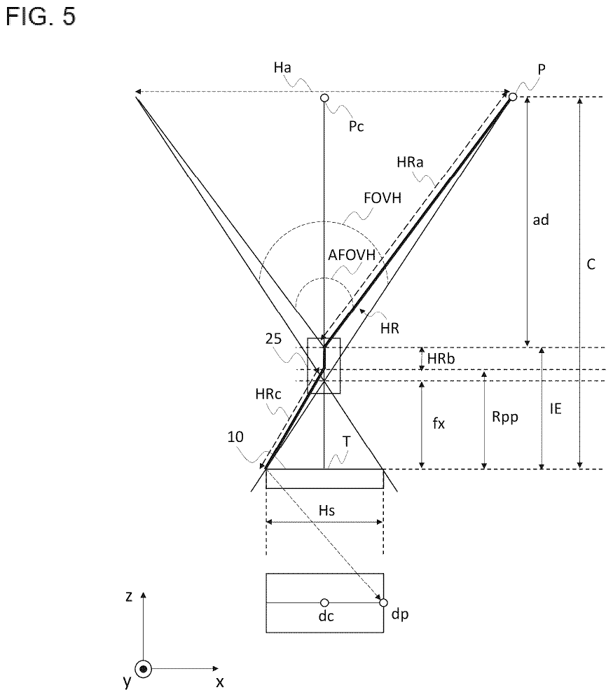

FIG. 5 shows a lens model in which the optical path length of the lens viewed from the y direction is considered. It is assumed that the distance from the light receiving surface T of the TOF sensor 10 to the subject is accurately obtained as the ranging value d in the lens model of FIG. 5. Therefore, the distance C from the central portion of the light receiving surface T of the TOF sensor 10 to the observation point Pc of the subject in the central portion of the angle of view is obtained by the ranging value d at the pixel in the central portion of the light receiving surface T aligned with the optical axis of the TOF sensor 10. Denoting the ranging value at the pixel in the central portion by dc, the ranging value dc is given by the following expression (14). The ranging value dc of the first embodiment is an example of the central ranging value.

dc=C expression (14)

The distance from the light receiving surface T of the TOF sensor 10 to the position of the entrance pupil of a lens 25 determined by considering the optical path length will be denoted by IE. A value predetermined according to the lens 25 is used as the distance IE to the position of the entrance pupil. Denoting the distance from the position of the entrance pupil to the observation point Pc of the subject in the central portion of the angle of view by ad, the distance ad is given by the following expression (15).

ad=C−IE expression (15)

Denoting the ranging value d of the observation point P of the subject, for which the vertical position is aligned with the optical axis of the lens 25 and the horizontal position is aligned with the maximum angle of view that can be captured by the TOF sensor 10 in the horizontal direction, by dp, the distance dp will be distance of the optical path length of the thick line HR of FIG. 5. The ranging value dp of the first embodiment is an example of the horizontal ranging value. Decomposing the thick line HR to HRa, HRb, HRc as shown in FIG. 5, HRa is given by the following expression (16).

HRa=HR−HRb−HRc=dp−HRb−HRc expression (16)

Denoting the maximum angle of view that can be captured by the TOF sensor 10 in the horizontal direction by AFOVH and denoting the distance between the ends of the maximum angle of view by Ha, the angle of view AFOV/2 and the distance Ha/2 can be determined as given by the following expressions (17) and (18) by using trigonometric functions.

AFOVH/2=arccos(ad/HRa)=arccos(ad/(dp−HRb−HRc)) expression (17)

Ha/2=ad×tan(AFOVH/2) expression (18)

The distance from the light receiving surface T of the TOF sensor 10 to the rear principal surface of the lens 25 determined by considering the optical path length will be denoted by Rpp. A value predetermined according to the lens 25 is used as the distance Rpp to the rear principal plane. The actual distance of HRb is given by the following expression (19) based on the distance IE to the position of the entrance pupil and the distance Rpp to the rear principal plane.

HRb=IE−Rpp expression (19)

The actual distance of HRc is given by the following expression (20) by using the square root, based on the horizontal effective size Hs of the TOF sensor 10 and the distance Rpp.

HRc=SQRT((Hs/2)\hat{ }2+Rpp\hat{ }2) expression (20)

The horizontal focal distance fx is determined by the following expression (21), which proportions the distance C=dc according to the ratio between Ha and the horizontal effective size Hs of the TOF sensor 10.

fx=Hs/(Ha+Hs)×dc=Hs/(2×ad×tan(AFOVH/2)+Hs)×dc=Hs/(2×(dc−IE)×tan(AFOVH/2)+Hs)×dc expression (21)

AFOVH/2 is given by the following expression (22) based on expression (17), expression (19), and expression (20).

AFOVH/2=arccos(ad/(dp−HRb−HRc))=arccos((dc−IE)/(dp−(IE−Rpp)−SQRT((Hs/2)\hat{ }2+Rpp\hat{ }2))) expression (22)

Thus, the horizontal focal distance fx according to the pinhole lens model can be determined from the values of the distances dc and dp measured by using the actual lens 25, by using the respective distances IE and Rpp to the position of the entrance pupil and the rear principal plane of the lens 25 and using the horizontal effective size Hs.

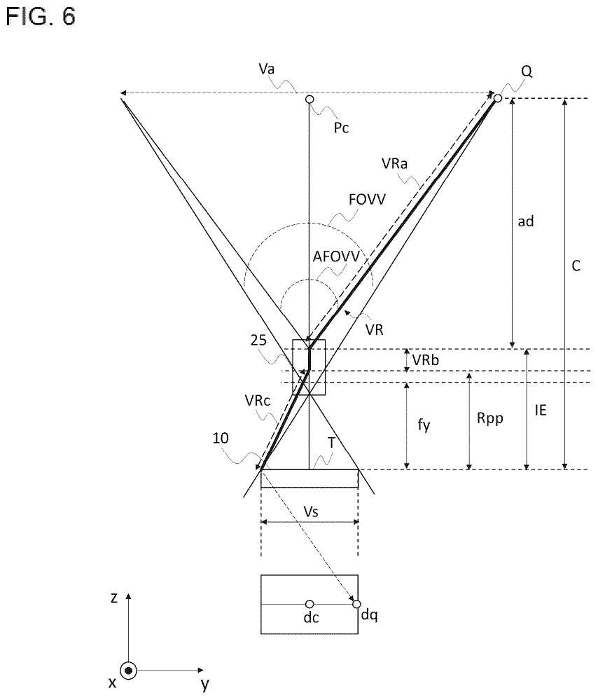

FIG. 6 shows a lens model in which the optical path length of the lens viewed from the x direction is considered. The maximum angle of view that can be captured by the TOF sensor 10 in the vertical direction will be denoted by AFOVV, and the size of the effective pixels of the TOF sensor 10 in the vertical direction will be denoted by Vs. The ranging value d of the observation point Q of the subject, for which the horizontal position is aligned with the optical axis of the lens 25 and the vertical position is aligned with the maximum angle of view that can be captured by the TOF sensor 10 in the vertical direction, will be denoted by dq. The ranging value dq of the first embodiment is an example of the vertical ranging value. The vertical focal distance fy is calculated in the same manner as the calculation of the horizontal focal distance fx and is given by the following expression (23).

fy=Vs/(2×(dc−IE)×tan(AFOVV/2)+Vs)×dc expression (23)

AFOVV/2 is given by the following expression (24).

AFOVV/2=arccos((dc−IE)/(dq−(IE−Rpp)−SQRT((Vs/2)\hat{ }2+Rpp\hat{ }2))) expression (24)

Thus, the vertical focal distance fy according to the pinhole lens model can be determined from the values of the distances dc and dq measured by using the actual lens 25, by using the respective distances IE and Rpp to the position of the entrance pupil and the rear principal plane of the lens 25 and using the vertical effective size Vs.

In the first embodiment, the horizontal focal distance fx and the vertical focal distance fy derived from converting the focal distance of the lens having a thickness to the focal distance according to the pinhole model can be obtained by acquiring the ranging value dc in the central portion of the angle of view, the ranging value dp at the horizontal end of the angle of view, and the ranging value dq at the vertical end of the angle of view. By inputting the horizontal focal distance fx and the vertical focal distance fy thus obtained to expression (1)-expression (13), the three-dimensional point cloud data, i.e., the distances Px, Py, Pz after point cloud conversion can be obtained.

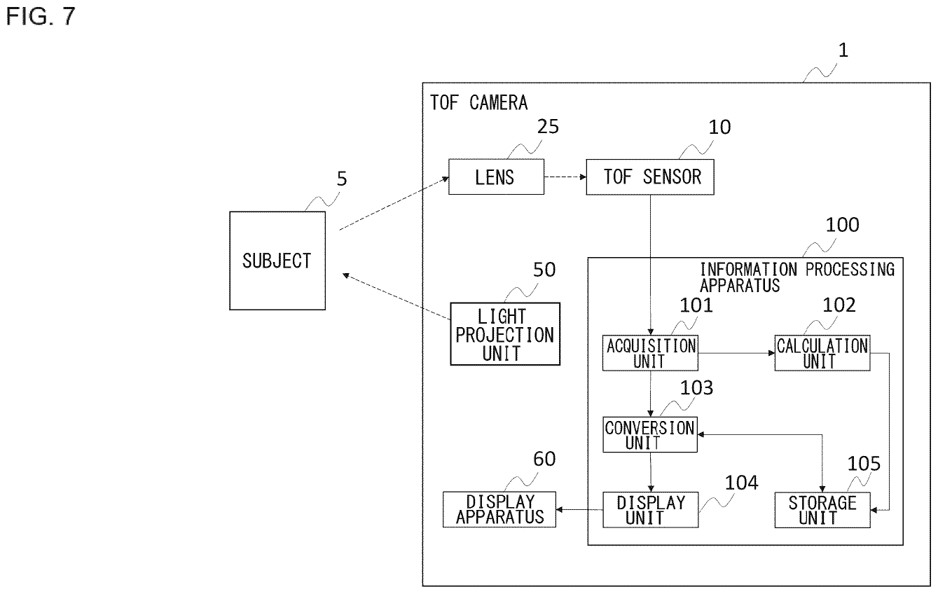

FIG. 7 shows a configuration of the TOF camera 1 of the first embodiment. The TOF camera 1 includes a TOF sensor 10, a lens 25, a light projection unit 50 that projects light in response to, for example, the user pressing the shooting button of the TOF camera 1, a display apparatus 60 having, for example, an LCD or an organic EL, and an information processing apparatus 100. The TOF sensor 10 generates multiple ranging values corresponding to the time of flight for light elapsed until the light projected from the light projection unit 50 is reflected by the subject, passes through the lens 25, and is received by the light receiving surface. The lens 25 may be a single lens or a combination of multiple lenses. The lens 25 of the first embodiment is an example of the optical system.

The information processing apparatus 100 includes an acquisition unit 101, a calculation unit 102, a conversion unit 103, a display unit 104, and a storage unit 105. These constituting elements can be implemented by cooperation between hardware resources and software resources or only by hardware resources. CPU, ROM, RAM, GPU (Graphics Processing Unit), DSP (Digital Signal Processor), ISP (Image Signal Processor), ASIC (Application Specific Integrated Circuit), FPGA (Field-Programmable Gate Array), and other LSIs can be used as hardware resources. As the software resources, programs such as firmware can be employed.

The acquisition unit 101 acquires the ranging value of the TOF sensor 10. The calculation unit 102 calculates the focal distance. The conversion unit 103 converts the ranging value to three-dimensional point cloud data. The display unit 104 causes the display apparatus 60 to display the three-dimensional point cloud data. The display unit 104 may cause another display apparatus outside the TOF camera 1 to display the three-dimensional point cloud data. The storage unit 105 stores the distance IE to the position of the entrance pupil of the lens 25, the distance Rpp to the rear principal plane of the lens 25, the horizontal effective size Hs, the vertical effective size Vs, threshold values, the focal distance, and a program for performing processes of the information processing apparatus 100.

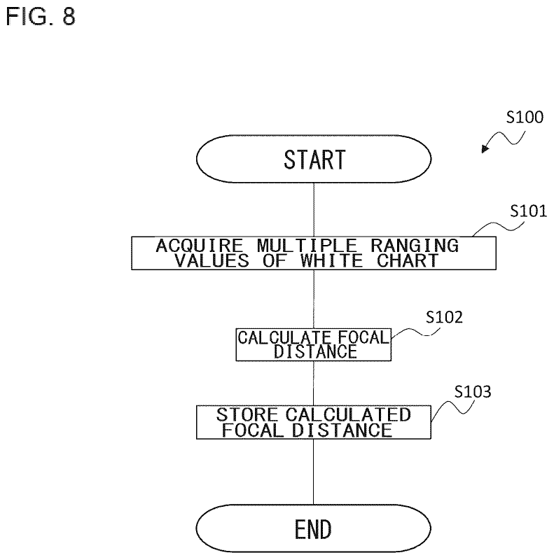

In the first stage of the first embodiment, a white chart is, for example, prepared as a planar subject 5 having high reflectance (e.g., 94% reflectance) with respect to the light projected by the TOF camera 1, and the focal distance is calibrated by using the white chart. FIG. 8 is a flowchart showing step S100 of the information processing apparatus 100 related to calibration of the first embodiment.

In step S101, the acquisition unit 101 acquires multiple ranging values of the white chart from the TOF sensor 10. For example, the acquisition unit 101 acquires multiple ranging values related to the white chart generated by detecting, on the light receiving surface of the TOF sensor 10, the light projected from the light projection unit 50 to the measurement range and reflected from the white chart. These multiple ranging values correspond to the time of flight of light elapsed until the light projected from the light projection unit 50 is reflected by the subject 5, passes through the lens 25, and is received by the light receiving surface of the TOF sensor 10.

In step S101, the distance between the TOF camera 1 and the white chart is adjusted so that the white chart is fully captured on the entire shooting screen of the TOF camera 1, and the white chart is photographed by the TOF camera 1. Thereby, multiple ranging values of the white chart are acquired.

In step S102, the calculation unit 102 calculates the horizontal focal distance fx and the vertical focal distance fy based on the multiple ranging values obtained. For example, the calculation unit 102 extracts, among the multiple ranging values acquired, the ranging value dc in the central portion of the angle of view, the ranging value dp at the horizontal end of the angle of view, and the ranging value dq at the vertical end of the angle of view and calculates the horizontal focal distance fx and the vertical focal distance fy by using the above expressions (21), (23), etc.

In step S103, the storage unit 105 stores the horizontal focal distance fx and the vertical focal distance fy thus calculated. After step S103, step S100 is terminated.

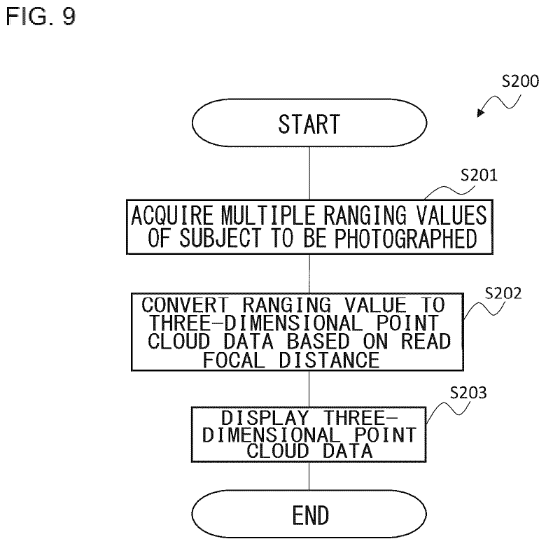

FIG. 9 is a flowchart of step S200 of the information processing apparatus 100 performed when a subject to be photographed is photographed to obtain three-dimensional point cloud data according to the first embodiment.

In step S201, the acquisition unit 101 acquires multiple ranging values of the subject to be photographed from the TOF sensor 10.

In step S202, the conversion unit 103 reads the horizontal focal distance fx and the vertical focal distance fy stored in step S103 from the storage unit 105 and converts the multiple ranging values to three-dimensional point cloud data based on the horizontal focal distance fx and the vertical focal distance fy thus read. For example, the conversion unit 103 converts each ranging value to three-dimensional point cloud data by calculating Px, Py, Pz for each ranging value by using the above expressions (8), (9), (13), etc., based on the horizontal focal distance fx and vertical focal distance fy read from the storage unit 105.

In step S203, the display unit 104 causes the display apparatus 60 to display the three-dimensional point cloud data. Further, the three-dimensional point cloud data is stored in the storage unit 105.

After step S203, step S200 is terminated.

Thus, in the first embodiment, the calculation unit 102 calculates the horizontal focal distance fx and the vertical focal distance fy based on the distance IE to the position of the entrance pupil of the lens 25, the distance Rpp to the rear principal plane of the lens 25, the horizontal effective size Hs, the vertical effective size Vs, and the ranging values dc, dp and dq. According to this feature, a high-precision focal distance considering the thickness of the lens can be obtained so that three-dimensional point cloud data can be obtained with good accuracy. In addition, it is not necessary to acquire multiple images by changing the orientation and the position of the checkered pattern chart spatially as in the related art so that it is possible to determine a proper focal distance more easily than in the related art.

A description will now be given of a variation.

In the embodiment, both horizontal focal distance fx and vertical focal distance fy are calculated, but at least one of the horizontal focal distance fx or the vertical focal distance fy may be calculated. For example, the acquisition unit 101 acquires at least one of the ranging values dp and dq. In this case, the calculation unit 102 may calculate at least one of the horizontal focal distance fx or the vertical focal distance fy based on at least one of the ranging values dp and dq, the ranging value dc, at least one of the horizontal effective size Hs or the vertical effective size Vs, and the distances IE and Rpp.

In the embodiment, the lens 25 may be comprised of one group and one lens (single lens) or comprised of one group and multiple lenses (cemented lens) so long as the position of the entrance pupil and the rear principal plane can be identified.

In the embodiment, multiple ranging values of the white chart were used, but the embodiment is not limited thereto, and multiple ranging values of any planar subject may be used.

### Second Embodiment

The second embodiment of the present disclosure will now be described. In the drawings and description of the second embodiment, the same or equivalent constituting elements, members as those of the first embodiment are denoted by the same reference numerals. Duplicative explanations from the first embodiment are omitted as appropriate, and features different from those of the first embodiment will be highlighted.

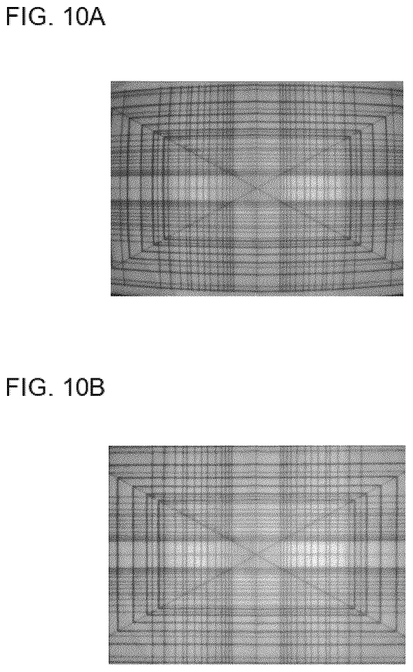

FIG. 10A shows a distance image obtained by using a distorted lens, and FIG. 10B shows an image obtained by subjecting the distance image of FIG. 10A to distortion correction. The distance image is an image showing a ranging value for each pixel. In the case that the lens of the TOF camera 1 is distorted, the TOF camera 1 detects the light passing through the distorted lens and acquires a ranging value. Therefore, the distance image obtained has distortion as shown in FIG. 10A. When this distance image having distortion is electrically corrected, the angle of view will be usually narrower than before the correction as shown in FIG. 10B. Therefore, the focal distance changes in a direction that is slightly larger than the focal distance inherently obtained in the lens, and the error from the actual focal distance increases. Therefore, there is a problem in that the deviation from the actual distance dimension becomes large when the ranging value is converted to three-dimensional point cloud data.

To obtain a focal distance in which distortion is considered, a scheme of calibrating the focal distance by using a checkered pattern chart is conceivable. As mentioned above, however, there is a problem of calibration man-hours and susceptibility lighting and noise.

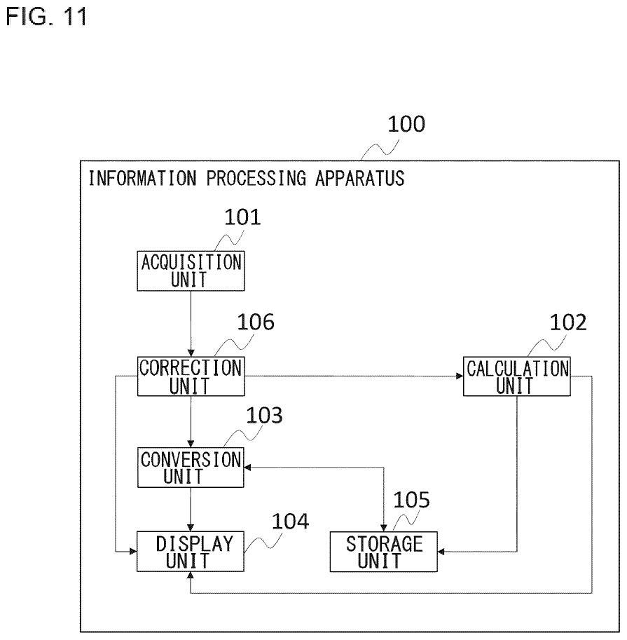

In view of the above, the second embodiment will be described. FIG. 11 shows a functional block diagram of the information processing apparatus 100 of the second embodiment. As shown in FIG. 11, the information processing apparatus 100 of the second embodiment further includes a correction unit 106 that subjects the distance image to distortion correction.

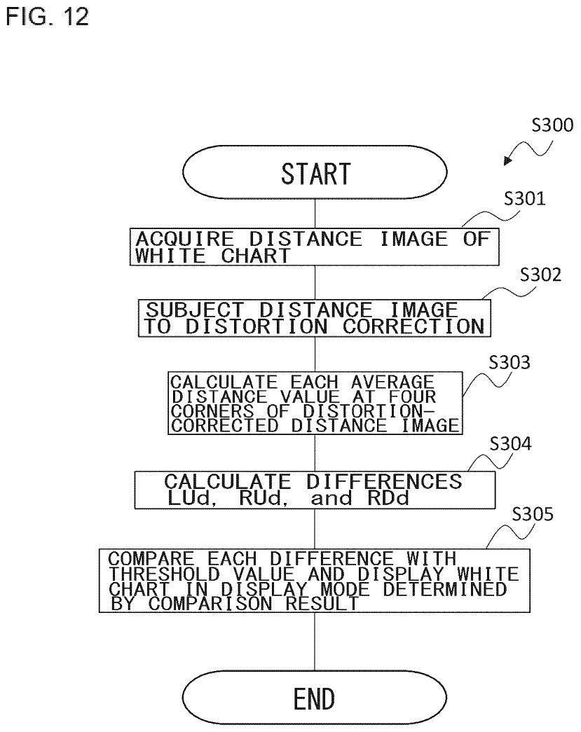

In the first stage of the second embodiment, a white chart having high reflectance (e.g., 94% reflectance) with respect to the light projected by the TOF camera 1 is prepared, and whether the white chart is arranged perpendicular to the optical axis of the TOF camera 1 is checked. FIG. 12 is a flowchart showing step S300 in the first stage for checking whether the TOF camera 1 is arranged perpendicular to its optical axis.

In step S301, the acquisition unit 101 acquires a distance image of the white chart from the TOF sensor 10. The distance between the TOF camera 1 and the white chart is adjusted so that the white chart is fully captured on the entire shooting screen of the TOF camera 1, and the white chart is photographed by the TOF camera 1. Thereby, a distance image of the white chart is acquired.

In step S302, the correction unit 106 subjects the acquired distance image to distortion correction. Distortion correction is performed by, for example, using the following expressions (25) and (26), which are commonly used.

X′=x/(1+k1×r\hat{ }2+k2×r\hat{ }4+k3×r\hat{ }6) expression (25)

Y′=y/(1+k1×r\hat{ }2+k2×r\hat{ }4+k3×r\hat{ }6) expression (26)

In expressions (25) and (26), r denotes the image height from the center of the screen, k1, k2, k3 denote distortion correction coefficients for adjustment according to the distortion of the lens, x denotes the position from the center of the screen in the horizontal direction, y denotes the position from the center of the screen in the vertical direction, X′ denotes the position from the center of the screen in the horizontal direction after correction, and Y′ denotes the position from the center of the screen in the vertical direction after correction. Hereinafter, the distortion correction coefficient may simply be denoted by k when it is described without distinguishing between k1, k2, k3.

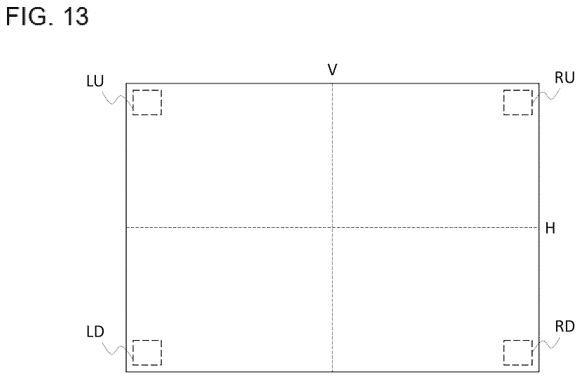

In step S303, the calculation unit 102 calculates an LU average distance value, a RU average distance value, an LD average distance value, and an RD average distance value indicating the distances to the respective 5 pixel×5 pixel regions LU, RU, LD, RD at the four corners of the screen (see FIG. 13) in the distortion-corrected distance image of the white chart. The LU average distance value, the RU average distance value, the LD average distance value, and the RD average distance value are the average values of the ranging values obtained in the regions LU, RU, LD, RD, respectively. The size of the region may not be 5×5 but may be set arbitrarily.

In step S304, the calculation unit 102 calculates an average value LRUD_AVE=(LU+RU+LD+RD)/4 of the LU average distance value, the RU average distance value, the LD average distance value, and the RD average distance value and calculates a difference between the average value LRUD_AVE and each of the LU average distance value, the RU average distance value, the LD average distance value, and the RD average distance value. For example, the calculation unit 102 calculates LUd=LU-LRUD_AVE, RUd=RU-LRUD_AVE, LDd=LD-LRUD_AVE, and RDd=RD-LRUD_AVE.

In step S305, the display unit 104 compares differences LUd, RUd, LDd, and RDd calculated for the respective regions LU, RU, LD, RD with an arbitrary threshold value Nt and causes the display apparatus 60 to display the photographed white chart in a display mode determined by the comparison result. When LUd>Nt, for example, the display unit 104 displays a portion in the white chart image corresponding to the region LU in red. When LUd<−Nt, for example, the display unit 104 displays a portion in the white chart image corresponding to the region LU in blue. When LUd≤Nt and LUd≥−Nt, for example, the display unit 104 displays a portion in the white chart image corresponding to the region LU in green. The display unit 104 equally displays portions corresponding to RUd, LDd, and RDd in different colors in accordance with the result of comparison with the threshold value Nt in the same manner as described above for LUd. The user looks at the screen colored in this way and performs pan and tilt adjustment of the TOF camera 1 so that all regions LU, RU, LD, RD are in green and fixes the TOF camera 1 when all regions LD, RU, LD, RD are in green.

After step S305, step S300 is terminated. Through steps S301-305, it is possible to check whether the white chart is arranged perpendicular to the optical axis of the TOF camera 1.

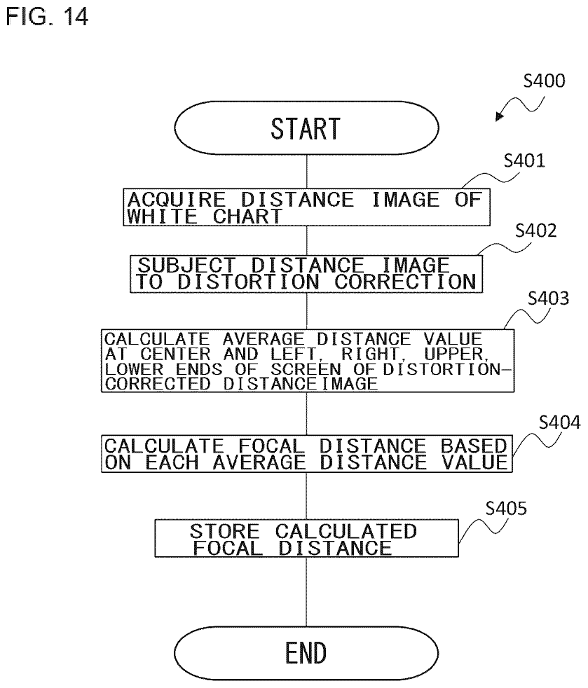

A description will now be given of the step of calculating the focal distance in the second stage of the second embodiment. FIG. 14 is a flowchart showing step S400 in the second stage for calculating the focal distance according to the second embodiment. The step S400 of FIG. 14 is performed in a state in which the white chart is arranged perpendicular to the optical axis of the TOF camera in step S300 of FIG. 12 and the TOF camera is fixed.

In step S401, the acquisition unit 101 acquires a distance image of the white chart. Since step S401 is for acquiring a distance image by using a white chart and is similar to step S301, a description thereof is omitted.

In step S402, the correction unit 106 subjects the acquired distance image to distortion correction. Since step S402 is similar to step S302, a description thereof is omitted.

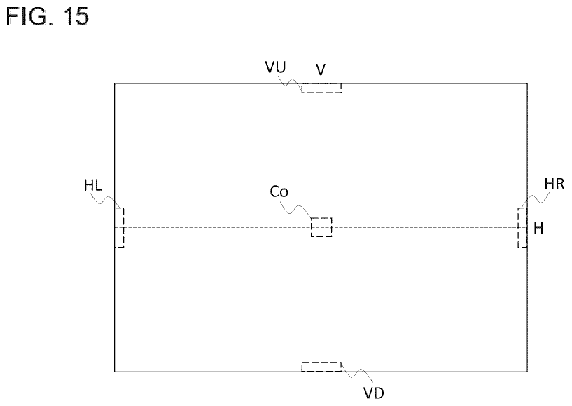

In step S403, the calculation unit 102 calculates a Co average distance value, a VU average distance value, a VU average distance value, a VD average distance value, an HL average distance value, and an HR average distance value indicating the distances to a 2×2 pixel region Co in the center of the screen, 4×2 pixel regions VU and VD located at the upper and lower ends with respect to the center of the screen, and 2×4 pixel regions HL and HR located at the left and right ends with respect to the center of the screen (see FIG. 15). In this process, the average distance value of each region may, the ranging value of each region is affected by much noise, be calculated by using a pixel-by-pixel moving average between frames so as to suppress noise.

In step S404, defining the average value HLR_AVE=(HL+HR)/2 of the HL average distance value and the HR average distance value as dp, defining the average value VUD_AVE=(VU+VD)/2 of the VU average distance value and the VD average distance value as dq, defining the average value C of the central region of the screen as dc, the calculation unit 102 calculates the horizontal focal distance fx and the vertical focal distance fy converted to the pinhole lens model by using expressions (21), (23), etc.

In step S405, the storage unit 105 stores the horizontal focal distance fx and the vertical focal distance fy thus calculated.

After step S405, step S400 is terminated.

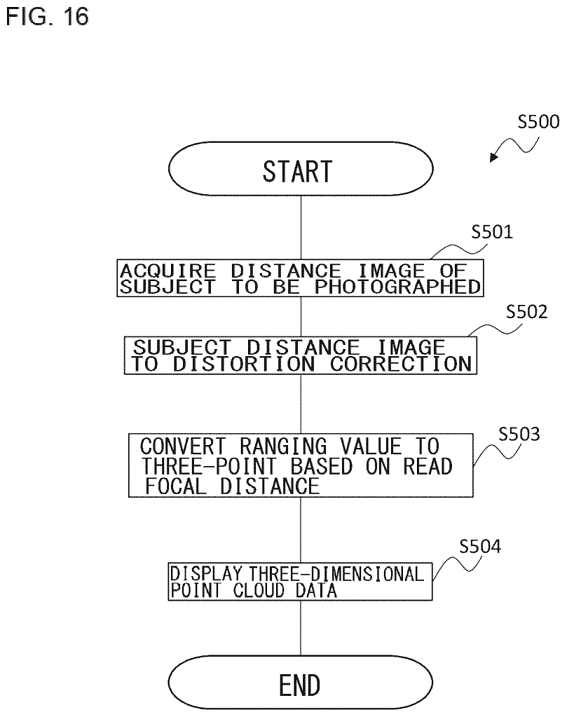

FIG. 16 is a flowchart of step S500 of the second embodiment performed when the subject 5 to be photographed is photographed to obtain three-dimensional point cloud data.

In step S501, the acquisition unit 101 acquires a distance image of the subject 5 to be photographed from the TOF sensor 10. Since step S501 is similar to step S301 except that the subject is not a white chart but an actual subject to be photographed, a description thereof is omitted.

In step S502, the correction unit 106 subjects the acquired distance image to distortion correction. Since step S502 is similar to step S302, a description thereof is omitted.

In step S503, the conversion unit 103 reads the horizontal focal distance fx and the vertical focal distance fy stored from the storage unit 105. Based on the horizontal focal distance fx and vertical focal distance fy thus read, the conversion unit 103 uses the above expressions (8), (9), (13), etc., to calculate Px, Py, Pz for each ranging value in the distortion-corrected distance image of the subject 5 to be photographed and converts each ranging value to three-dimensional point cloud data. In this way, three-dimensional point cloud data with a distance dimension closer to the actual distance can be obtained. Since the focal distance of the lens does not vary significantly with the distance to the subject 5, three-dimensional point cloud data with a distance dimension closer to the actual distance can be obtained even if various subjects 5 are photographed.

In step S503, the display unit 104 causes the display apparatus 60 to display the three-dimensional point cloud data. Further, the three-dimensional point cloud data is stored in the storage unit 105.

After step S503, step S500 is terminated. In the case of a still image, the process may be terminated at this point of time, but, when a point cloud is generated as moving images, step S500 is performed for each frame.

Thus, according to the second embodiment, the horizontal focal distance fx and the vertical focal distance fy are determined by using the distance image obtained by subjecting the distance image obtained by the lens 25 actually provided in the TOF camera 1 to distortion correction. Therefore, the focal distance converted to the pinhole lens model, in which actual distortion correction is considered, can be obtained. In addition, the proper focal distance can be determined simply by adjusting the position of the TOF camera 1 by using a white chart and photographing the chart, the workload required to determine the proper focal distance can be reduced.

In step S403, the average value of the average distance values of the respective regions at the upper and lower ends of the screen and at the left and right ends of the screen was used to reduce the influence of noise, but the embodiment is not limited thereto. The average distance value of the respective regions at one of the upper and lower ends and at one of the left and right ends or the ranging values at one of the upper and lower ends and at one of the left and right ends may be used.

In the second embodiment, both the horizontal focal distance fx and vertical focal distance fy are calculated, but at least one of the horizontal focal distance fx or the vertical focal distance fy may be calculated. For example, the calculation unit 102 may calculate at least one of the horizontal focal distance fx or the vertical focal distance fy based on at least one of the horizontal ranging value at the horizontal end of the distortion-corrected distance image and the vertical ranging value at the vertical end thereof, the central ranging value, at least one of the horizontal effective size Hs or the vertical effective size Vs, and the distances IE and Rpp.

In the second embodiment, a distance image of a white chart is used, but the embodiment is not limited thereto. A distance image of any planar subject may be used. Alternatively, the information processing apparatus 100 may input the distance image and the infrared light image subjected to distortion correction by the correction unit 106 to the display unit 104, bypassing the conversion unit 103, and cause the display apparatus 60 to display the images. In this process, the information processing apparatus 100 may cause the display apparatus 60 to display the respective regions LU, RU, LD, and RD, and Co, VU, VD, HL, and HR for which the average distance values are calculated in steps S303 and S403.

### Third Embodiment

The third embodiment of the present disclosure will now be described. In the drawings and description of the third embodiment, the same or equivalent constituting elements, members as those of the second embodiment are denoted by the same reference numerals. Duplicative explanations from the second embodiment are omitted as appropriate, and features different from those of the second embodiment will be highlighted.

The method of the second embodiment described above is effective for unifocal lenses. However, it is not necessarily effective for zoom lenses because the focal distance and the proper distortion correction coefficient change every time the zoom position changes. Normally, the wide end of the distance image of a zoom lens is distorted in the shape of a barrel. When the distance image is corrected for distortion, the image is slightly enlarged and the angle of view is slightly narrowed. In this case, conversion of the ranging value to three-dimensional point cloud data does not strictly result in an accurate distance unless the focal distance is slightly increased. Also, barrel distortion normally decreases gradually as the zoom lens is driven toward the tele end. Some lenses have pincushion distortion toward the tele end, and pincushion distortion is also slightly magnified by distortion correction. Therefore, conversion of the ranging value to three-dimensional point cloud data does not strictly result in an accurate distance unless the focal distance is slightly increased. Therefore, calibration and point cloud conversion adapted to the zoom lens are required. In view of the above background, the third embodiment will be described.

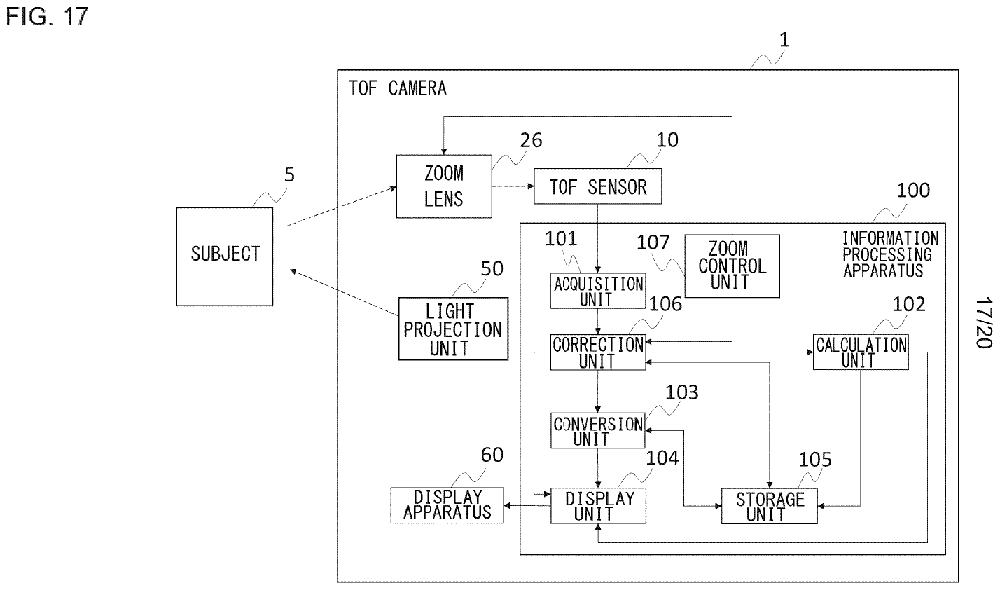

FIG. 17 shows a configuration of the TOF camera 1 of the third embodiment. The TOF camera 1 of the third embodiment includes a zoom lens 26 in which a zoom operation for changing the focal distance is enabled. The information processing apparatus 100 of the third embodiment further includes a zoom control unit 107 that controls the zoom operation of the zoom lens 26. The zoom lens 26 of the third embodiment is an example of the optical system.

The zoom control unit 107 outputs a zoom control value ZC for controlling the zoom operation of the zoom lens 26 mounted on the TOF camera 1 to the zoom lens 26. It is assumed that the zoom control value ZC is, for example, presented in an 8-bit value of 0-255 and is defined as a value derived from dividing the extent from the wide end to the tele end by 256. The actuator (not shown) of the zoom lens 26 performs a zoom operation according to the zoom control value ZC.

The zoom control unit 107 further outputs the zoom control value ZC to the correction unit 106. The correction unit 106 performs optimal distortion correction for each input zoom control value ZC based on the distance image obtained by using the zoom lens 26. For example, the storage unit 105 retains 256 distortion correction coefficients corresponding to the respective zoom control values ZC and derived from dividing, by 256, the distortion correction coefficient k of the commonly used expressions (25) and (26) that correct the distortion non-linearly in accordance with the image height. The correction unit 106 reads from the storage unit 105 the distortion correction coefficient k that optimally corrects the lens distortion during a zoom indicated by the zoom control value ZC and corrects the distortion in the distance image with the distortion correction coefficient.

The step of calculating the focal distance for each zoom control value ZC will be described hereinafter. First, in the first stage, step S300 of FIG. 12 described above is performed to check whether the white chart is arranged perpendicular to the optical axis of the TOF camera 1, and the position of the TOF camera 1 is established.

Then, in the second stage, the information processing apparatus 100 performs step S400 of FIG. 15 for each zoom control value ZC to calculate the horizontal focal distance fx and the vertical focal distance fy. The horizontal focal distance fx and the vertical focal distance fy of the third embodiment are retained in the storage unit 105 in the form of 256 horizontal focal distances fx[ZC] (i.e., fx[0]−fx) and 256 fy[ZC] (i.e., fy[0]−fy), respectively, each length being linked to the zoom control value ZC.

Given, for example, that the zoom control value ZC=0 at the wide end, the information processing apparatus 100 performs step S400 of FIG. 15 to calculate the horizontal focal distance fx and the vertical focal distance fy in the case of the zoom control value ZC=0. The horizontal focal distance fx and the vertical focal distance fy calculated at the zoom control value ZC=0 are stored in the storage area of the storage unit 105 for fx[ZC]=fx[0], fy[ZC]=fy[0].

The value of the zoom control value ZC is then advanced by 1 to result in the zoom control value ZC=1, and the zoom lens 26 is shifted from the wide end toward the tele side by one step. The information processing apparatus 100 performs step S400 to calculate the horizontal focal distance fx and the vertical focal distance fy in the case of the zoom control value ZC=1. The calculation result is stored in the storage area for fx[ZC]=fx[1] and fy[ZC]=fy[1] in the storage unit 105.

The calculation of the horizontal focal distance fx and the vertical focal distance fy for each zoom control value ZC is performed until the position of the zoom lens 26 is the tele end. As a result, the horizontal focal distance fx[ZC] and the vertical focal distance fy[ZC] from the wide end to the tele end are stored in the storage unit 105.

When actually photographing the subject 5 to be photographed, the information processing apparatus 100 performs step S500 of FIG. 16. The information processing apparatus 100 instantly reads the horizontal focal distance fx[ZC] and the vertical focal distance fy[ZC] corresponding to the zoom control value ZC from the storage unit 105 every time the zoom lens 26 is controlled and performs point cloud conversion based on the focal distance.

Thus, in the third embodiment, the correction unit 106 performs distortion correction based on the zoom control value. According to this feature, a point cloud with an optimal distance dimension and closer to the actual distance can be obtained even when a zoom operation is performed.

### Fourth Embodiment

The fourth embodiment of the present disclosure will now be described. In the drawings and description of the fourth embodiment, the same or equivalent constituting elements, members as those of the third embodiment are denoted by the same reference numerals. Duplicative explanations from the third embodiment are omitted as appropriate, and features different from those of the third embodiment will be highlighted.

If the proper focal distance can be applied to each of lenses with different movable ranges of focal distance, a more versatile TOF camera 1 can be realized. This is addressed by the fourth embodiment by providing the TOF camera 1 with the C lens mount in which lenses having different movable ranges of focal distance can be switchably used.

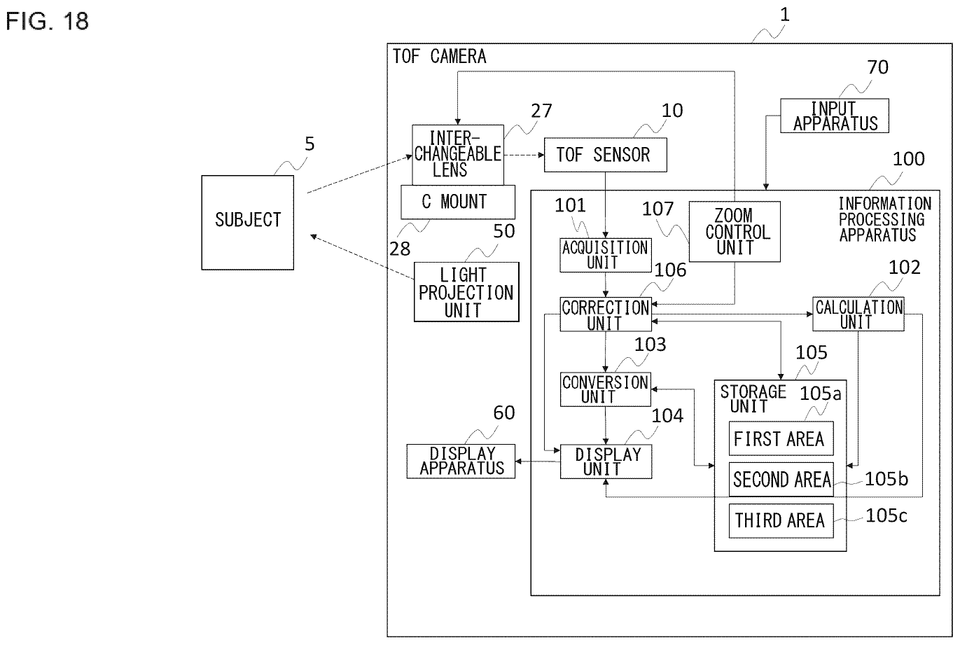

FIG. 18 shows a configuration of the TOF camera 1 of the fourth embodiment. The TOF camera 1 of the fourth embodiment includes an interchangeable lens 27 that is an interchangeable zoom lens, a C mount 28 for mounting the interchangeable lens 27 on the TOF camera 1, and an input apparatus 70 adapted to receive a user input. The interchangeable lens 27 of the fourth embodiment is selected from zoom lenses having different movable ranges of focal distance according to the user's application and mounted on the TOF camera 1. The interchangeable lens 27 of the fourth embodiment is an example of the optical system.

The storage unit 105 of the fourth embodiment retains, for example, 256 distortion correction coefficients k corresponding to the respective zoom control value ZC for each of the three types of interchangeable lenses 27 having different movable ranges of focal distance. For example, the storage unit 105 has a first area 105a that stores 256 distortion correction coefficients k corresponding to the respective zoom control values ZC of the first type of interchangeable lens 27, a second area 105b that stores 256 distortion correction coefficients k corresponding to the respective zoom control values ZC of the second type of interchangeable lens 27, and a third area 105c that stores 256 distortion correction coefficients k corresponding to the respective zoom control values ZC of the third type of interchangeable lens 27.

The step of calculating the focal distance for each interchangeable lens 27 will be described hereinafter. For example, the user sets index numbers 1-3 in these first-third areas 105a-105c, respectively, via the input apparatus 70 and designates the index number corresponding to the interchangeable lens 27 mounted among the three types of interchangeable lenses 27. The index number indicates the type of the interchangeable lens 27. For example, it is assumed that the index number 1 related to the first area 105a is designated. After this designation, the step of calculating the focal distance for each zoom control value ZC described in the third embodiment is performed. The correction unit 106 reads the distortion correction factor k corresponding to the designated index number 1 and the zoom control value ZC from the first area 105a of the storage unit 105 and corrects the distance image. Given that the zoom control value ZC=0, for example, the calculation unit 102 performs steps S403 and S404 of FIG. 14 for the zoom control value ZC=0 to calculate the horizontal focal distance fx[INDEX] [ZC]=fx[1] [0] and the vertical focal distance fy[INDEX] [ZC]=fy[1] [0]. The storage unit 105 stores the focal distances fx[1] [0] and fy[1] [0] thus obtained in the first area 105a corresponding to the index number 1 and the zoom control value ZC=0. These steps are repeated for each zoom control value ZC at the index number 1, and the horizontal focal distance fx[INDEX] [ZC] and the vertical focal distance fy[INDEX] [ZC] for the index number 1 and each zoom control value ZC are stored in the first area 105a corresponding to the index number 1 and each zoom control value ZC.

The user then replaces, for example, the interchangeable lens 27 with the interchangeable lens 27 corresponding to the index number 2, designates the index number 2 via the input apparatus 70, and then performs the step of calculating the focal distance for each zoom control value ZC. The correction unit 106 reads the distortion correction coefficient k corresponding to the designated index number 2 and the zoom control value ZC from the second area 105b of the storage unit 105 and corrects the distance image. Given that the zoom control value ZC=0, for example, the calculation unit 102 performs steps S403 and S404 of FIG. 14 for the zoom control value ZC=0 to calculate the horizontal focal distance fx[INDEX] [ZC]=fx[2] [0] and the vertical focal distance fy[INDEX] [ZC]=fy[2] [0]. The storage unit 105 stores the focal distances fx[2] [0] and fy[2] [0] thus obtained in the second area 105b corresponding to the index number 2 and the zoom control value ZC=0. These steps are repeated for each zoom control value ZC at the index number 2. In this way, the storage unit 105 stores the horizontal focal distance fx[INDEX] [ZC] and the vertical focal distance fy[INDEX] [ZC] for the index number 2 and each zoom control value ZC in the second area 105b corresponding to the index number 2 and each zoom control value ZC.

The user then replaces, for example, the interchangeable lens 27 with the interchangeable lens 27 corresponding to the index number 3, designates the index number 3 via the input apparatus 70, and then performs the step of calculating the focal distance for each zoom control value ZC. The correction unit 106 reads the distortion correction coefficient k corresponding to the designated index number 3 and the zoom control value ZC from the third area 105c of the storage unit 105 and corrects the distance image. Given that the zoom control value ZC=0, for example, the calculation unit 102 performs steps S403 and S404 of FIG. 14 for each zoom control value ZC to calculate the horizontal focal distance fx[INDEX] [ZC]=fx[3] [0] and the vertical focal distance fy[INDEX] [ZC]=fy[3] [0] for the zoom control value ZC=0. The storage unit 105 stores the focal distances fx[3] [0] and fy[3] [0] thus obtained in the third area 105c corresponding to the index number 3 and the zoom control value ZC=0. These steps are repeated for each zoom control value ZC at the index number 3. In this way, the storage unit 105 stores the horizontal focal distance fx[INDEX] [ZC] and the vertical focal distance fy[INDEX] [ZC] for the index number 3 and each zoom control value ZC in the third area 105c corresponding to the index number 3 and each zoom control value ZC.

When the subject is actually photographed, the index number of the interchangeable lens 27 mounted is designated. This prompts the conversion unit 103 to instantly read the horizontal focal distance fx[INDEX] [ZC] and the vertical focal distance fy[INDEX] [ZC] corresponding to the zoom control value ZC from the storage unit 105 every time the interchangeable lens 27 is controlled and performs point cloud conversion based on the focal distance.

Thus, in the fourth embodiment, the correction unit 106 performs distortion correction based further on the type of the interchangeable lens 27 selected in addition to the zoom control value ZC. According to this feature, a point cloud with an optimal distance dimension and closer to the actual distance can be obtained in accordance with the interchangeable lens 27 selected.

In the fourth embodiment, an example of using three types of interchangeable lenses 27 is shown, but the embodiment is not limited to three types, and two or more types may be used.

### Fifth Embodiment

The fifth embodiment of the present disclosure will now be described. In the drawings and description of the fifth embodiment, the same or equivalent constituting elements, members as those of the fourth embodiment are denoted by the same reference numerals. Duplicative explanations from the fourth embodiment are omitted as appropriate, and features different from those of the fourth embodiment will be highlighted.

By further utilizing an RGB color image of the subject to generate three-dimensional point cloud data, it is possible to reproduce a three-dimensional model closer to the reality. Depending on the distortion of the lens, the zoom control value ZC, and the movable range of focal distance described above, however, the arrangement of RGB in the color image obtained from the reflected light from the subject will vary. Even if the distance image is properly converted to a three-dimensional point cloud in consideration of the distortion of the lens, the zoom control value ZC, and the movable area of focal distance as in the fourth embodiment above, therefore, the RGB color image of the subject may not be properly arranged in the three-dimensional point cloud data. In view of the above, the fifth embodiment will be described.

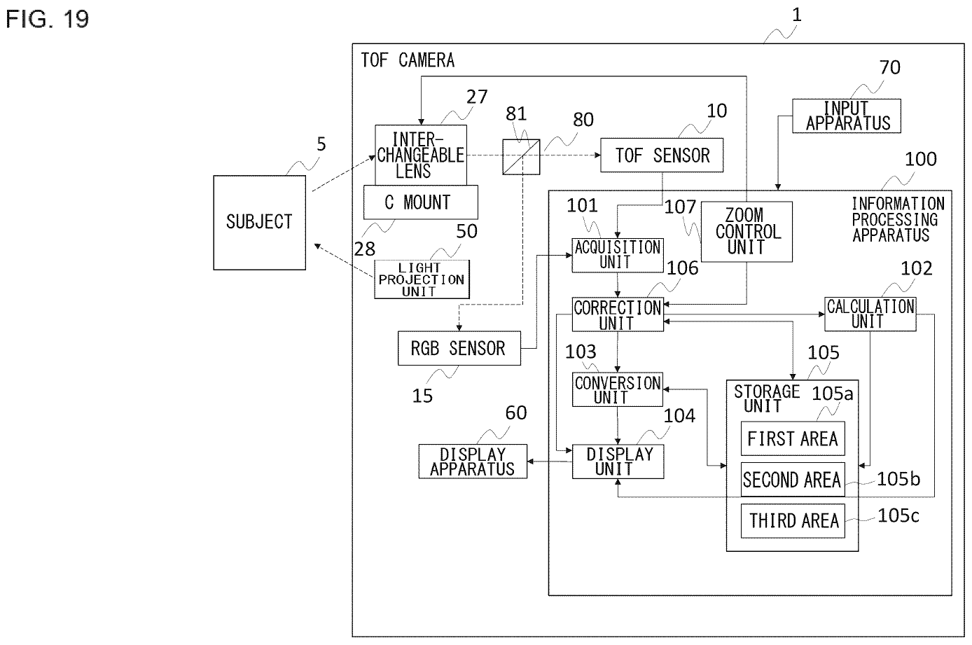

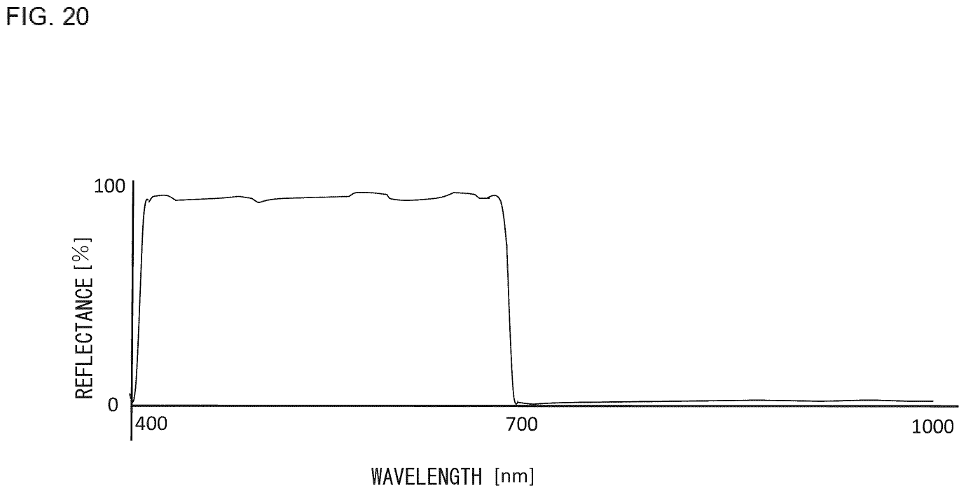

FIG. 19 shows a configuration of the TOF camera 1 of the fifth embodiment. The TOF camera 1 of the fifth embodiment includes a prism 80 that disperses the light passing through the interchangeable lens 27 and an RGB sensor 15 that generates an RGB color image of the subject from the visible light reflected by the subject. The color image is an image presenting RGB color values for each pixel. The prism 80 includes a visible light reflection dichroic film 81. For example, the visible light reflection dichroic film 81 has the reflection spectral characteristics shown in FIG. 20. The visible light reflection dichroic film 81 reflects visible light having a wavelength of 400-700 [nm], outputs the reflected light to the RGB sensor 15, transmits the near infrared light projected from the light projection unit 50 (e.g., the infrared light having a wavelength of 940 [nm]), and outputs the transmitted light to the TOF sensor 10. The TOF sensor 10 and the RGB sensor 15 of the fifth embodiment are arranged on the same optical axis by using the prism 80. The color image of the subject detected by the RGB sensor 15 is assumed to have the same angle of view and the same number of pixels as the distance image detected by the TOF sensor 10.

The ambient visible light and the near infrared light projected from the light projection unit 50 are reflected by the subject, pass through the interchangeable lens 27, and is incident on the prism 80. Of the light incident on the prism 80, the visible light is reflected by the visible light reflection dichroic film 81 and is incident on the RGB sensor 15. The near infrared light passes through the visible light reflection dichroic film 81 and is incident on the TOF sensor 10.

Since the focal distance calculation method using the ranging value of the TOF sensor 10 is the same as that of the fourth embodiment, a description thereof is omitted. In the following, the method of properly arranging the RGB color image of the subject in the generated three-dimensional point cloud data in consideration of lens distortion, etc. will be described.

To correct the chromatic aberration of magnification of the interchangeable lens 27 in addition to distortion correction of the interchangeable lens 27, the storage unit 105 of the fifth embodiment retains 256 distortion correction coefficients k derived from dividing, by 256, the distortion correction coefficient k of expressions (25) and (26) for each of the R, G, B channels. In other words, the storage unit 105 stores 256 distortion correction coefficients k for each of R, G, B. Further, as in the fourth embodiment, the storage unit 105 of the fifth embodiment sets an index number for each interchangeable lens 27 and retains 256 distortion correction coefficients k corresponding to the zoom control value ZC for each index number.

The acquisition unit 101 acquires a color image of the subject from the RGB sensor 15. The correction unit 106 reads, from the storage unit 105, the distortion correction coefficient k corresponding to the index number designated by the user via the input apparatus 70 and the zoom control value ZC and subjects the color image to distortion correction by using expressions (25) and (26). The conversion unit 103 generates three-dimensional point cloud data reflecting the color of the subject by arranging the color image corrected for chromatic aberration and distortion in the three-dimensional point cloud data. The display unit 104 causes the display apparatus 60 to display the three-dimensional point cloud data reflecting the color of the subject.

In the fifth embodiment, the correction unit 106 subjects the color image to distortion correction, and the conversion unit 103 generates three-dimensional point cloud data reflecting the color of the subject by arranging the distortion-corrected color image in the three-dimensional point cloud data. According to this feature, the color image can be properly arranged in the three-dimensional point cloud data by using the distortion-corrected color image so that a three-dimensional model closer to the reality can be provided.

In the fifth embodiment, the correction unit 106 subjects the color image to distortion correction based on the index number and the zoom control value ZC, but the embodiment is not limited thereto. The correction unit 106 may perform distortion correction without using the index number and the zoom control value ZC.

### Sixth Embodiment

The sixth embodiment of the present disclosure will now be described. In the drawings and description of the sixth embodiment, the same or equivalent constituting elements, members as those of the fifth embodiment are denoted by the same reference numerals. Duplicative explanations from the fifth embodiment are omitted as appropriate, and features different from those of the fifth embodiment will be highlighted.

The storage unit 105 of the sixth embodiment stores the distance IE to the position of the entrance pupil corresponding to each zoom control value ZC and the distance Rpp to the rear principal plane. The calculation unit 102 of the sixth embodiment reads the distances IE and Rpp corresponding to each zoom control value ZC and calculate horizontal focal distance fx and the vertical focal distance fy by using expressions (21), (23), etc. based on the distances IE and Rpp thus read.

The distance IE to the position of the entrance pupil and the distance Rpp to the rear principal plane vary depending on the zoom control value ZC. According to the sixth embodiment, the horizontal focal distance fx and the vertical focal distance fy can be calculated by using the proper distances IE and Rpp for each zoom control value ZC. Therefore, the accuracy of the focal distance can be further improved.

The embodiment is intended to be illustrative only and it will be understood by those skilled in the art that various modifications to combinations of constituting elements and processes are possible and that such modifications are also within the scope of the present disclosure.

What is claimed is:

1. An information processing apparatus comprising:
an acquisition unit that acquires, from a TOF sensor that generates a distance image comprised of a plurality of ranging values corresponding to a time of flight for light elapsed until a projected light is reflected by a subject, passes through an optical system, and is received by a light receiving surface, the plurality of ranging values; and
a calculation unit that calculates a focal distance of the optical system in at least one of a horizontal direction or a vertical direction, based on i) of the plurality of ranging values, at least one of a horizontal ranging value that is a ranging value of an observation point of the subject aligned with a maximum angle of view of the TOF sensor in the horizontal direction or a vertical ranging value that is a ranging value of an observation point of the subject aligned with the maximum angle of view of the TOF sensor in the vertical direction, ii) of the plurality of ranging values, a central ranging value that is a ranging value of an observation point of the subject aligned with a central portion of the angle of view of the TOF sensor, iii) a distance from the light receiving surface to a rear principal surface of the optical system, iv) a distance from the light receiving surface to a position of an entrance pupil of the optical system, and v) an effective size of the TOF sensor in at least one of the horizontal direction or the vertical direction.

2. The information processing apparatus according to claim 1,
wherein the calculation unit calculates the focal distance in the horizontal direction and the vertical direction such that
fx=Hs/(2×(dc−IE)×tan(AFOVH/2)+Hs)×dc
fy=Vs/(2×(dc−IE)×tan(AFOVV/2)+Vs)×dc
and
AFOVH/2=arccos((dc−IE)/(dp−(IE−Rpp)−SQRT((Hs/2)\hat{ }2+Rpp\hat{ }2)))
AFOVV/2=arccos((dc−IE)/(dq−(IE−Rpp)−SQRT((Vs/2)\hat{ }2+Rpp\hat{ }2)))
where Rpp denotes a distance from the light receiving surface to the rear principal surface of the optical system, IE denotes a distance from the light receiving surface to the position of the entrance pupil of the optical system, Hs denotes the effective size of the TOF sensor in the horizontal direction, and Vs denotes the effective size of the TOF sensor in the vertical direction, AFOVH denotes the maximum angle of view of the TOF sensor in the horizontal direction, AFOVV denotes the maximum angle of view of the TOF sensor in the vertical direction, dc denotes the central ranging value, dp denotes the horizontal ranging value, dq denotes the vertical ranging value, fx denotes the focal distance in the horizontal direction, and fy denotes the focal distance in the vertical direction.

3. The information processing apparatus according to claim 1, further comprising:
a storage unit that stores the focal distance calculated; and
a conversion unit that converts the plurality of ranging values to three-dimensional point cloud data based on the focal distance stored in the storage unit.

4. A method comprising:
acquiring, from a TOF sensor that generates a distance image comprised of a plurality of ranging values corresponding to a time of flight for light elapsed until a projected light is reflected by a subject, passes through an optical system, and is received by a light receiving surface, the plurality of ranging values; and
calculating a focal distance of the optical system in at least one of a horizontal direction or a vertical direction, based on i) of the plurality of ranging values, at least one of a horizontal ranging value that is a ranging value of an observation point of the subject aligned with a maximum angle of view of the TOF sensor in the horizontal direction or a vertical ranging value that is a ranging value of an observation point of the subject aligned with the maximum angle of view of the TOF sensor in the vertical direction, ii) of the plurality of ranging values, a central ranging value that is a ranging value of an observation point of the subject aligned with a central portion of the angle of view of the TOF sensor, iii) a distance from the light receiving surface to a rear principal surface of the optical system, iv) a distance from the light receiving surface to a position of an entrance pupil of the optical system, and v) an effective size of the TOF sensor in at least one of the horizontal direction or the vertical direction.

5. An information processing apparatus comprising:
an acquisition unit that acquires, from a TOF sensor that generates a distance image comprised of a plurality of ranging values corresponding to a time of flight for light elapsed until a projected light is reflected by a subject, passes through an optical system, and is received by a light receiving surface, the distance image of the subject;
a correction unit that subjects the distance image to distortion correction;
a calculation unit that calculates a focal distance of the optical system in at least one of a horizontal direction or a vertical direction, based on i) at least one of a horizontal ranging value that is a ranging value at an end of the distance image subjected to distortion correction in a horizontal direction or a vertical ranging value that is a ranging value at an end of the distance image subjected to distortion correction in a vertical direction, ii) a central ranging value that is a ranging value in a central portion of the distance image subjected to distortion correction, iii) a distance from the light receiving surface to a rear principal surface of the optical system, iv) a distance from the light receiving surface to a position of an entrance pupil of the optical system, and v) an effective size of the TOF sensor in at least one of the horizontal direction or the vertical direction; and
a storage unit that stores the focal distance calculated.

6. The information processing apparatus according to claim 5,
wherein the optical system is a zoom lens in which a zoom operation for changing a focal distance is enabled,
wherein the information processing apparatus comprises a zoom control unit that controls a zoom control value for controlling the zoom operation, and
wherein the correction unit performs distortion correction based on the zoom control value.

7. The information processing apparatus according to claim 6,
wherein the information processing apparatus further comprises a conversion unit that converts the plurality of ranging values to three-dimensional point cloud data based on the focal distance stored in the storage unit,
wherein the calculation unit calculates the focal distance subjected to distortion correction for each zoom control value to store the calculated focal distance for each zoom control value in the storage unit, and
wherein the conversion unit reads the focal distance corresponding to the zoom control value from the storage unit every time the zoom lens is controlled to convert the plurality of ranging values to three-dimensional point cloud data based on the read focal distance.

8. The information processing apparatus according to claim 6,
wherein the optical system is a zoom lens selected from zoom lenses having different movable ranges of focal distance, and
wherein the correction unit performs distortion correction based further on a type of a selected zoom lens.

9. The information processing apparatus according to claim 5,
wherein the information processing apparatus further comprises a conversion unit that converts the plurality of ranging values to three-dimensional point cloud data based on the focal distance stored in the storage unit,
wherein the acquisition unit acquires a color image of the subject from an RGB sensor that generates the color image of the subject from a visible light reflected by the subject,
wherein the correction unit subjects the color image to distortion correction, and
wherein the conversion unit generates the three-dimensional point cloud data reflecting a color of the subject by arranging the color image subjected to distortion correction in the three-dimensional point cloud data.
